(19) United States
(12) Patent Application Publication
(10) Pub. No.: US 2025/0052036 A1
(43) Pub. Date: Feb. 13, 2025

(54) MOBILE MACHINE WITH BATTERY POWERED ACTUATOR SYSTEM

(71) Applicant: Moog Inc., East Aurora, NY (US)

(72) Inventor: David Geiger, Hamburg, NY (US)

(21) Appl. No.: 18/696,053

(22) PCT Filed: Sep. 28, 2022
(86) PCT No.: PCT/US2022/045054

§ 371 Date: Mar. 27, 2024

Related U.S. Application Data
(60) Provisional application No. 63/249,669, filed on Sep. 29, 2021.

(51) Int. Cl. E02F 9/22

(52) U.S. Cl. CPC E02F 9/2246; E02F 9/2217; E02F 9/2296

(57) ABSTRACT

A mobile machine comprising an object to be driven, an electric storage, an electric motor connected to the electric storage, a hydraulic pump driven by the electric motor, a hydraulic piston assembly hydraulically connected to the pump and comprising a housing having a first chamber, a second chamber, a piston separating the first and second chambers, and an actuating rod connected to the piston and the object to be driven, the hydraulic piston assembly configured to actuate the object to be driven relative to the mobile machine within a range of motion, and wherein actuation of the object to be driven relative to the body portion of the mobile machine within the range of motion is controllable by the electric motor and powered via the electric storage.

### TECHNICAL FIELD

The present disclosed subject matter relates generally to the field of mobile machines, and more particularly to a mobile machine with an improved battery powered actuator system.

### BACKGROUND

Mobile machines are generally land vehicles with attached machinery or equipment that are self-propelled or mobile and that, in contrast to automobiles, provide functionality beyond conveying people from one point to another. Mobile machines are known to include, without limitation, forklifts, skid steers, excavators, tractors, earthmovers, farm machinery, dump trucks, garbage trucks, mobile cranes, and other mobile construction equipment.

### BRIEF SUMMARY

With parenthetical reference to the corresponding parts, portions or surfaces of the disclosed embodiment, merely for purposes of illustration and not by way of limitation, an improved mobile machine is provided comprising: an object (18) configured to be driven relative to a body portion (17) of the mobile machine (15); an electric storage (19); an electric motor (52a) connected to the electric storage and configured to be supplied with a current and to operatively provide a torque on an output shaft; a hydraulic pump (53a) driven by the output shaft of the electric motor; a hydraulic piston assembly (20a) hydraulically connected to the hydraulic pump and comprising a housing (24a) having a first chamber (25a) and a second chamber (26a), and a piston (27a) separating the first and second chambers of the housing; an actuating rod (28a) connected to the piston and configured to move linearly with the piston relative to the housing; one of the housing or the actuating rod connected to the mobile machine and the other of the housing or the actuating rod connected to the object to be driven; the hydraulic piston assembly configured to actuate the object to be driven relative to the mobile machine within a range of motion; and wherein actuation of the object to be driven relative to the body portion of the mobile machine within the range of motion is controllable by the electric motor and powered via the electric storage.

The mobile machine may comprise a hydraulic release (55a, 56a) between the pump and the hydraulic piston assembly operatively configured to release hydraulic fluid from the first chamber or the second chamber when a pressure in the first chamber or the second chamber exceeds a threshold value. The hydraulic release may comprise a first release valve (56a) between the first chamber and the pump, a second release valve (55a) between the second chamber and the pump, a first check valve (57a) between the first chamber and the second release valve, and a second check valve (56a) between the second chamber and the first release valve.

The mobile machine may comprise a hydraulic brake (58a, 59a) between the pump and the hydraulic piston assembly operatively configured to hold the object to be driven relative to the mobile machine in a braked position within the range of motion. The hydraulic brake may comprise a solenoid valve between the first chamber and the second chamber. The mobile machine may comprise a controller (60) that receives input signals and outputs command signals to the electric motor to control actuation of the object to be driven relative to the body portion of the mobile machine. The mobile machine may comprise a pressure sensor (41) configured to sense a braking pressure of the hydraulic piston assembly when the object to be driven is held in the braked position within the range of motion by the hydraulic brake and to provide a pressure input signal to the controller. The electric motor may be controlled by the controller based on the pressure input signal when the hydraulic brake releases the hold of the object to be driven from the braked position.

The mobile machine may comprise: a second hydraulic piston assembly (20b) hydraulically connected to the hydraulic pump (53a) and comprising a second housing (24b) having a first chamber (25b) and a second chamber (26b), and a second piston (27b) separating the first and second chambers of the second housing; a second actuating rod (28b) connected to the second piston and configured to move linearly with the second piston relative to the second housing; one of the second housing or the second actuating rod connected to the mobile machine and the other of the second housing or the second actuating rod connected to the object to be driven (18); the second hydraulic piston assembly configured to actuate the object to be driven relative to the body portion of the mobile machine within the range of motion; and wherein actuation of the object to be driven relative to the body portion of the mobile machine within the second range of motion may be controllable by the electric motor and powered via the electric storage.

The mobile machine may comprise: a second electric motor (52b) connected to the electric storage (19) and adapted to be supplied with a current and to operatively provide a torque on a second output shaft; a second hydraulic pump (53b) driven by the second output shaft of the second electric motor; a second hydraulic piston assembly (21a) hydraulically connected to the second hydraulic pump and comprising a second housing (24c) having a first chamber (25c) and a second chamber (26c), and a second piston (27c) separating the first and second chambers of the second housing; a second actuating rod (28c) connected to the second piston and configured to move linearly with the second piston relative to the second housing; one of the second housing or the second actuating rod connected to the mobile machine (17) and the other of the second housing or the second actuating rod connected to the object to be driven (18); the second hydraulic piston assembly configured to actuate the object to be driven relative to the mobile machine within a second range of motion; and wherein actuation of the object to be driven relative to the body portion of the mobile machine within the second range of motion may be controllable by the second electric motor and powered via the electric storage. The range of motion may comprise rotational motion about a tilt axis and the second range of motion may comprise translational motion along a lift axis. The mobile machine may comprise a skid steer loader and the object to be driven may comprise a bucket configured to be lifted and tilted relative to the body portion of the mobile machine. The mobile machine may comprise a fluid reservoir (30) connected to the hydraulic pump, the second hydraulic pump, the hydraulic piston assembly, and the second hydraulic piston assembly; and the hydraulic pump, the second hydraulic pump, the hydraulic piston assembly, the second hydraulic piston assembly, and the reservoir may be connected in a substantially closed hydraulic system.

The mobile machine may comprise: a second object configured to be driven relative to the body portion of the mobile machine; a second electric motor (52c) connected to the electric storage (19) and adapted to be supplied with a current and to operatively provide a torque on a second output shaft; a second hydraulic pump (53c) driven by the second output shaft of the second electric motor; a second hydraulic piston assembly hydraulically connected to the second hydraulic pump and comprising a second housing having a first chamber and a second chamber, and a second piston separating the first and second chambers of the second housing; a second actuating rod connected to the second piston and configured to move linearly with the second piston relative to the second housing; one of the second housing or the second actuating rod connected to the mobile machine and the other of the second housing or the second actuating rod connected to the second object to be driven; the second hydraulic piston assembly configured to actuate the second object to be driven relative to the mobile machine within a second range of motion; and wherein actuation of the second object to be driven relative to the body portion of the mobile machine within the second range of motion may be controllable by the second electric motor and powered via the electric storage. The mobile machine may comprise: a fluid reservoir (30) connected to the hydraulic pump, the second hydraulic pump, the hydraulic piston assembly, and the second hydraulic piston assembly; and the hydraulic pump, the second hydraulic pump, the hydraulic piston assembly, the second hydraulic piston assembly, and the reservoir may be connected in a substantially closed hydraulic system.

The mobile machine may comprise a skid steer loader and the object to be driven may comprise a bucket configured to be lifted and tilted relative to the body portion of the mobile machine. The mobile machine may comprise a controller (60) that receives input signals and outputs command signals to the electric motor to control actuation of the object to be driven relative to the body portion of the mobile machine. The mobile machine may comprise a regenerative power stage (51a) to the electric motor and the electric motor may be controlled by the controller to operate in a regeneration mode.

The mobile machine may comprise a position sensor configured to sense a position of the first piston and to provide an input signal to the controller. The mobile machine may comprise a pressure sensor configured to sense pressure in the first chamber and/or the second chamber and to provide an input signal to the controller. The electric motor may be a variable speed bidirectional electric motor adapted to operatively provide a torque on the output shaft at varying speeds and by direction, the hydraulic pump may be a reversible variable speed hydraulic pump, and actuation of the object to be driven relative to the body portion of the mobile machine within the range of motion may be controllable by adjusting the speed and/or direction of the variable speed bidirectional electric motor. The electric motor may comprise a brushless DC servo-motor. The hydraulic pump may be selected from a group consisting of a fixed displacement pump, a variable displacement pump, a two-port pump, and a three-port pump. The piston may comprise a first surface area exposed to the first chamber of the housing and a second surface area exposed to the second chamber of the housing. The housing may comprise a cylinder having a first end wall, wherein the piston is disposed in the cylinder for sealed sliding movement therealong, and wherein the actuator rod is connected to the piston for movement therewith and comprises a portion sealingly penetrating the first end wall. The housing may be connected to the body portion of the mobile machine and the actuating rod may be connected to the object to be driven. The mobile machine may comprise a fluid reservoir (30) connected to the hydraulic pump and the hydraulic piston assembly; and the hydraulic pump, the hydraulic piston assembly and the reservoir may be connected in a substantially closed hydraulic system.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a representative perspective view of a first embodiment of an improved mobile machine.

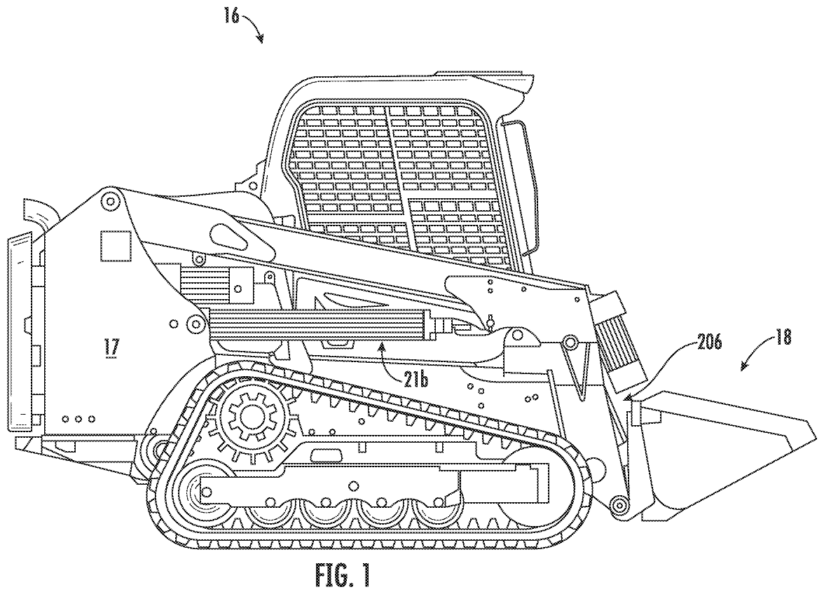

FIG. 2 is a top schematic view of the mobile machine shown in FIG. 1.

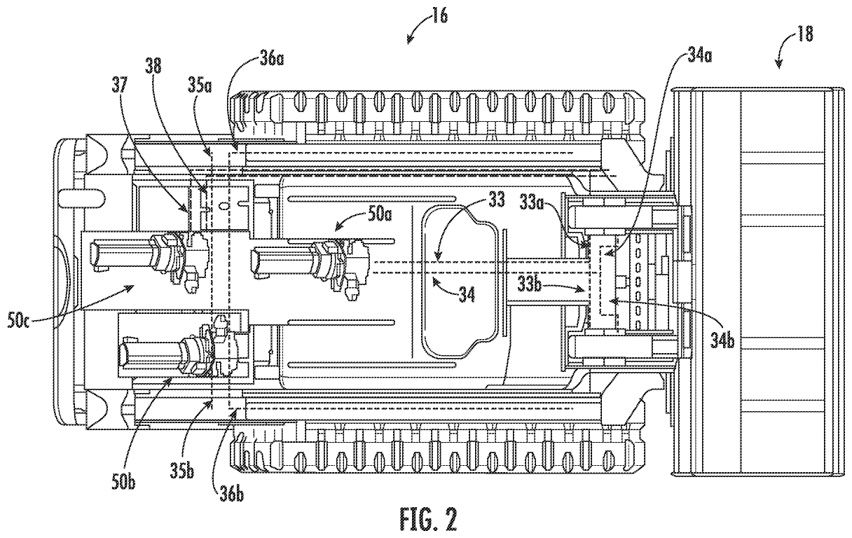

FIG. 3 is a schematic system diagram of the mobile machine electro-hydraulic actuator system shown in FIG. 2.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

It is to be appreciated that the present teaching is by way of example only, not by limitation. The concepts herein are not limited to use or application with a specific system or method. Thus, although the instrumentalities described herein are for the convenience of explanation, shown and described with respect to exemplary embodiments, it will be appreciated that the principles herein may be applied equally in other types of systems and methods.

Where they are used herein, the terms “first,” “second,” and so forth, do not necessarily denote any ordinal, sequential or priority relation, but are simply used to distinguish one element or set of elements more clearly from another element or set of elements, unless specified otherwise.

Referring to the drawings, an improved battery powered actuator system for a mobile machine is provided, of which a first embodiment is generally indicated at 15. In this embodiment, battery powered actuator system 15 actuates parallel tilt cylinders 20a and 20b and parallel lift cylinders 21a and 21b of bucket 18 of skid steer loader 15 relative to body 17 of skid steer loader 16. In this embodiment, battery powered actuator system 15 also provides an accessory manifold module for actuating accessory implements. While actuator system 15 is shown in this embodiment actuating bucket 18, other skid steer attachments may be driven by actuation system 15, including without limitation brush cutters, bale squeezes, mowers, pallet forks, and snow blowers.

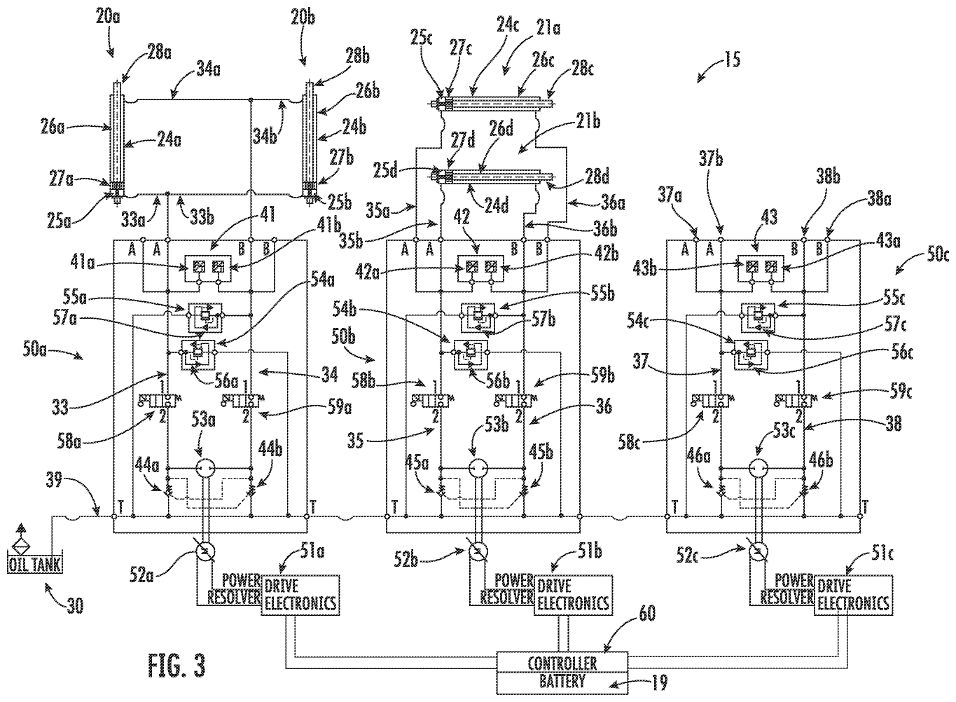

As shown in FIG. 3, actuation system 15 general includes tilt motor pump assembly 50a, lift motor pump assembly 50b, accessory motor pump assembly 50c, hydraulic piston tilt assemblies 20a and 20b, hydraulic piston lift assemblies 21a and 21b, system fluid tank 30, and battery system 19, all supported on body 17 of skid steer 16.

Tilt motor pump assembly 50a generally includes drive electronics 51a, variable speed bidirectional electric servomotor 52a, and bidirectional or reversible pump 53a driven by motor 52a. Lift motor pump assembly 50b generally includes drive electronics 51b, variable speed bidirectional electric servomotor 52b, and bidirectional or reversible pump 53b driven by motor 52b. Accessory motor pump assembly 50c generally includes drive electronics 51c, variable speed bidirectional electric servomotor 52c, and bidirectional or reversible pump 53c driven by motor 52c.

Hydraulic lines run from each of the motor and pump assemblies to each of the respective hydraulic cylinders, with lines 37 and 38 feeding an accessory implements cylinder from pump 53c, lines 33, 33a, 33b, 34, 34a and 34b feeding bucket 18 tilt cylinders 20a and 20b from pump 53a, and lines 35a, 35b, 36a and 36b feeding bucket 18 lift cylinders 21a and 21b from pump 53b. System 15 may be employed in a variety of other applications, including without limitation in applications in which diesel engines are replaced with electrical systems. For example, and without limitation, the system may be employed in excavators, wheel loaders and in other mobile equipment or machines that require multiple actuation elements.

In this embodiment, motors 52a, 52b and 52c are each brushless D.C. variable-speed servo-motors that are supplied with a current via battery 19 and drive electronics 51a, 51b, and 51c, respectively. Motors 52a, 52b and 52c each have an inner rotor with permanent magnets and a fixed non-rotating stator with coil windings. When current is appropriately applied through the coils of the stator, a magnetic field is induced. The magnetic field interaction between the stator and rotor generates torque which may rotate the motor output shaft. When the supplied current is of one polarity, the motor will rotate in one direction. When the supplied current supplied is of the opposite polarity, the motor will rotate in the opposite direction. Accordingly, the motor will selectively apply a torque on its output shaft in one direction about the motor axis at varying speeds and will apply a torque on its output shaft in the opposite direction about the motor axis at varying speeds. Other motors may be used as alternatives. For example, a variable speed stepper motor, brush motor or induction motor may be used.

Motor controllers 51a, 51b and 51c are connected to battery system 19 and receive power from battery system 19. System controller 60 communicates with motor controllers 51a, 51b and 51c, which in turn supply a current of the appropriate magnitude and polarity to motors 52a, 52b and 52c, respectively. Motor controllers 51a, 51b and 51c include drive electronics that, based on a resolver angular position feedback, generate and commutate the stator fields to vary the speed and direction of motors 52a, 52b and 52c, respectively.

In this embodiment, pumps 53a, 53b and 53c are each fixed displacement bi-directional internal two-port gear pumps. The pumping elements, namely gears, are capable of rotating in either direction, thereby allowing hydraulic fluid to flow in either direction. This allows for oil to be added into and out of the system as the system controller closes the control loop of position or pressure. The shaft of at least one gear of each of pumps 53a, 53b and 53c is connected to the output shaft of motors 52a, 52b and 52c, respectively, with the other pump gear following. The direction of flow of each of pumps 53a, 53b and 53c depends on the direction of rotation of the connected motors 52a, 52b and 52c, respectively. In addition, the speed and output of the respective pump is variable with variations in the speed of its connected motor. Other bi-directional pumps may be used as alternatives. For example, a variable displacement pump may be used.

In this embodiment, hydraulic piston assembly 20a includes piston 27a slidably disposed within cylindrical housing 24a such that piston 27a may be driven in both directions relative to housing 24a. Piston 27a sealingly separates chamber 25a from chamber 26a. As shown, one side or port of pump 53a communicates with chamber 25a via fluid line 33 and the opposite side or port of pump 53a communicates with chamber 26a via fluid line 34. Piston 27a is connected to actuating rod 28a. Bidirectional motor 52a turns bidirectional pump 53a and bidirectional pump 53a is hydraulically connected to piston actuator 20a. Pump 53a and piston actuator 20a form a hydrostatic transmission, so as pump 53a spins in a first direction, piston 27a and rod 28a move in a first direction and as pump 53a spins in the other direction, piston 27a and rod 28a move in the other direction. Thus, piston 27a will extend or move rod 28a up when bidirectional motor 52a is rotated in a first direction, thereby rotating bidirectional pump 53a in a first direction and drawing fluid in through a pump port from line 34 and chamber 26a and out from a pump port and into line 33 and chamber 25a. Piston 27a will retract rod 28a or move to down when bidirectional motor 52a is rotated in the other direction, rotating bidirectional pump 53a in the other direction and drawing fluid in through a pump port from line 33 and chamber 25a and out from a pump port and into line 34 and chamber 26a.

Hydraulic piston assembly 20b is orientated parallel to hydraulic piston assembly 20a and is configured to operate in tandem with hydraulic piston assembly 20a. Similar to hydraulic piston assembly 20a, hydraulic piston assembly 20b includes piston 27b slidably disposed within cylindrical housing 24b such that piston 27b may be driven in both directions relative to housing 24b. Piston 27b sealingly separates chamber 25b from chamber 26b. As shown, one side or port of pump 53a communicates with chamber 25b via fluid line 33 and the opposite side or port of pump 53a communicates with chamber 26b via fluid line 34. Piston 27b is connected to actuating rod 28b. Bidirectional pump 53b is hydraulically connected to piston actuator 20b. Pump 53a and piston actuator 20b form a hydrostatic transmission, so as pump 53a spins in a first direction, piston 27b and rod 28b move in a first direction and as pump 53a spins in the other direction, piston 27b and rod 28b move in the other direction. Thus, piston 27b will extend or move rod 28b up when bidirectional motor 52a is rotated in a first direction, thereby rotating bidirectional pump 53a in a first direction and drawing fluid in through a pump port from line 34 and chamber 26b and out from a pump port and into line 33 and chamber 25b. Piston 27b will retract rod 28b or move to down when bidirectional motor 52a is rotated in the other direction, rotating bidirectional pump 53a in the other direction and drawing fluid in through a pump port from line 33 and chamber 25b and out from a pump port and into line 34 and chamber 26b.

In this embodiment, hydraulic piston assembly 21a includes piston 27c slidably disposed within cylindrical housing 24c such that piston 27c may be driven in both directions relative to housing 24c. Piston 27c sealingly separates left chamber 25c from right chamber 26c. As shown, one side or port of pump 53b communicates with left chamber 25c via fluid line 35 and the opposite side or port of pump 53b communicates with right chamber 26c via fluid line 36. Piston 27c is connected to actuating rod 28c. Bidirectional motor 52b turns bidirectional pump 53b and bidirectional pump 53b is hydraulically connected to piston actuator 21a. Pump 53b and piston actuator 21a are a hydrostatic transmission, so as pump 53b spins in a first direction, piston 27c and rod 28c move in a first direction and as pump 53b spins in the other direction, piston 27c and rod 28c move in the other direction. Thus, piston 27c will extend or move rod 28c to the right when bidirectional motor 52b is rotated in a first direction, thereby rotating bidirectional pump 53b in a first direction and drawing fluid in through a pump port from line 36 and chamber 26c and out from a pump port and into line 35 and chamber 25c. Piston 27c will retract rod 28c or move to the left when bidirectional motor 52b is rotated in the other direction, rotating bidirectional pump 53b in the other direction and drawing fluid in through a pump port from line 35 and chamber 25c and out from a pump port and into line 36 and chamber 26c.

Hydraulic piston assembly 21b is orientated parallel to hydraulic piston assembly 21a and is configured to operate in tandem with hydraulic piston assembly 21a. Similar to hydraulic piston assembly 21a, hydraulic piston assembly 21b includes piston 27d slidably disposed within cylindrical housing 24d such that piston 27d may be driven in both directions relative to housing 24d. Piston 27d sealingly separates left chamber 25d from right chamber 26d. As shown, one side or port of pump 53b communicates with left chamber 25d via fluid line 35 and the opposite side or port of pump 53b communicates with right chamber 26d via fluid line 36. Piston 27d is connected to actuating rod 28d. Bidirectional motor 52b turns bidirectional pump 53b and bidirectional pump 53b is also hydraulically connected to piston actuator 21b. Pump 53b and piston actuator 21b form a hydrostatic transmission, so as pump 53b spins in a first direction, piston 27d and rod 28d move in a first direction and as pump 53b spins in the other direction, piston 27d and rod 28d move in the other direction. Thus, piston 27d will extend or move rod 28d to the right when bidirectional motor 52b is rotated in a first direction, thereby rotating bidirectional pump 53b in a first direction and drawing fluid in through a pump port from line 36 and chamber 26d and out from a pump port and into line 35 and chamber 25d. Piston 27d will retract rod 28d or move to the left when bidirectional motor 52b is rotated in the other direction, rotating bidirectional pump 53b in the other direction and drawing fluid in through a pump port from line 35 and chamber 25d and out from a pump port and into line 36 and chamber 26d.

In this embodiment, accessory motor pump assembly 50c includes piston chamber connections 37a, 37b, 38a and 38b. As shown, one side or port of pump 53c communicates with left chamber connections 37a and 37b via fluid line 37 and the opposite side or port of pump 53c communicates with right chamber connection 38a and 38b via fluid line 38. Thus, when bidirectional motor 52c is rotated in a first direction, thereby rotating bidirectional pump 53c in a first direction, fluid would be drawn in through a pump port from line 37 and chamber connections 37a and 37b and out from a pump port and into line 38 and chamber connections 38a and 38b. When bidirectional motor 52c is rotated in the other direction, thereby rotating bidirectional pump 53c in the other direction, fluid would be drawn in through a pump port from line 38 and chamber connections 38a and 38b and out from a pump port and into line 37 and chamber connections 37a and 37b.

Hydraulic manifold assembly 50a includes hydraulic brake valves 58a and 59a between pump 53a and hydraulic piston assemblies 20a and 20b. In particular, valve 58a is fluid line 33 between pump 53a and chambers 25a and 25b of hydraulic piston assemblies 20a and 20b, respectively, and valve 59a is in line 34 between pump 53a and chambers 26a and 26b of hydraulic piston assemblies 20a and 20b, respectively. Valves 58a and 59a are operatively configured to hold pistons 27a and 27b, and thereby the tilt of bucket 18, in a braked position relative to cylinders 24a and 24b. In this embodiment, valves 58a and 59a are both active valves that employ an external actuation force to open or close, rather than passive valves in which the operational state of open or closed is determined by the fluid the valve controls (e.g. a check valve). In this embodiment valves 58a and 59a are two-way two-port solenoid valves. When valves 58a and 59a are energized, the valve is held open, thereby allowing equalization of fluid pressure on each side of the valve and flow through the valve in either direction. When valves 58a and 59a are de-energized, the spring of the solenoid valve will bias it to blocked port and closed, thereby blocking flow in either direction through the valve. Thus, in the event of a power failure, valves 58a and 59a will close and maintain pressure in chambers 25a, 25b, 26a and 26b to brake pistons 27a and 27b and bucket 18 in the controlled tilt range of motion.

Hydraulic manifold assembly 50a also includes hydraulic release valves 54a and 55a between pump 53a and hydraulic piston assemblies 20a and 20b. In particular, release valve 54a is fluid line 33 between pump 53a and chambers 25a and 25b of hydraulic piston assemblies 20a and 20b, respectively, and release valve 55a is in line 34 between pump 53a and chambers 26a and 26b of hydraulic piston assemblies 20a and 20b, respectively. Release valves 54a and 55a communicate with tank 30 and include anticavitation check valves 56a and 57a. Release valve 54a is operatively configured to release hydraulic fluid from chambers 25a and 25b when the pressure in such chambers exceeds a threshold value, such as from a high shock loading of bucket 18 that could otherwise damage mobile machine 18. Check valve 57a is in turn operatively configured to open line 34 to tank 30 via negative pressure in line 34 and chambers 26a and 26b upon sudden release of fluid and pressure from line 33. Thus, reservoir 30 is recharged and discharged, as appropriate, to accommodate the differential fluid volumes on each side of pistons 27a and 27b from a shock releasing event. Similarly, release valve 55a is operatively configured to release hydraulic fluid from chambers 26a and 26b when the pressure in such chambers exceeds a threshold value. Check valve 56a is in turn operatively configured to open line 33 to tank 30 via negative pressure in line 33 and chambers 25a and 25b upon sudden release of fluid and pressure from line 34, with reservoir 30 recharged and discharged, as appropriate, to accommodate differential fluid volumes on each side of pistons 27a and 27b from a shock releasing event.

In this embodiment, hydraulic manifold assembly 50a also includes pressure sensor assembly 41, which includes pressure transducer 41a and pressure transducer 41b. Pressure transducer 41a is in line 33 between braking valve 58a and chambers 25a and 25b and is configured to sense pressure in chambers 25a and 25b, including when hydraulic brake valve 58a is closed and bucket 18 is held in a braked position within its tilt range of motion, and provides a pressure input signal to controller 60. Similarly, pressure transducer 41b is in line 34 between braking valve 59a and chambers 26a and 26b and is configured to sense pressure in chambers 26a and 26b, including when hydraulic brake valve 59a is closed and bucket 18 is held in a braked position within its tilt range of motion, and provides a pressure input signal to controller 60. Controller 60 and drive electronics 51a may thereby provide a current to motor 52a that corresponds to the sensed pressure feedback from pressure sensor 41 to remove any pressure differential between the opposite sides of hydraulic brakes 58a and 59a, respectively, and thereby reduce any jump or jerk in pistons 27a and 27b when hydraulic brake valves 58a and 59a are opened and release their hold of pistons 27a and 27b and bucket 18 from a braked tilt position.

Hydraulic manifold assembly 50b includes hydraulic brake valves 58b and 59b between pump 53b and hydraulic piston assemblies 21a and 21b. In particular, valve 58b is fluid line 35 between pump 53b and chambers 25c and 25d of hydraulic piston assemblies 21a and 21b, respectively, and valve 59b is in line 36 between pump 53b and chambers 26c and 26d of hydraulic piston assemblies 21a and 21b, respectively. Valves 58b and 59b are operatively configured to hold pistons 27c and 27d, and thereby the height of bucket 18, in a braked position relative to cylinders 24c and 24d. In this embodiment, valves 58b and 59b are both active valves that employ an external actuation force to open or close, rather than passive valves in which the operational state of open or closed is determined by the fluid the valve controls (e.g. a check valve). In this embodiment valves 58b and 59b are two-way two-port solenoid valves. When valves 58b and 59b are energized, the valve is held open, thereby allowing equalization of fluid pressure on each side of the valve and flow through the valve in either direction. When valves 58b and 59b are de-energized, the spring of the solenoid valve will bias it to blocked port and closed, thereby blocking flow in either direction through the valve. Thus, in the event of a power failure, valves 58b and 59b will close and maintain pressure in chambers 25c, 25d, 26c and 26d to brake pistons 27c and 27d and bucket 18 in the controlled lift range of motion.

Hydraulic manifold assembly 50b also includes hydraulic release valves 54b and 55b between pump 53b and hydraulic piston assemblies 21a and 21b. In particular, release valve 54b is fluid line 35 between pump 53b and chambers 25c and 25d of hydraulic piston assemblies 21a and 21b, respectively, and release valve 55b is in line 36 between pump 53b and chambers 26c and 26d of hydraulic piston assemblies 21a and 21b, respectively. Release valves 54b and 55b communicate with tank 30 and include anticavitation check valves 56b and 57b. Release valve 54b is operatively configured to release hydraulic fluid from chambers 25c and 25d when the pressure in such chambers exceeds a threshold value, such as from a high shock loading of bucket 18 that could otherwise damage mobile machine 18. Check valve 57b is in turn operatively configured to open line 36 to tank 30 via negative pressure in line 36 and chambers 26c and 26d upon sudden release of fluid and pressure from line 35. Thus, reservoir 30 is recharged and discharged, as appropriate, to accommodate the differential fluid volumes on each side of pistons 27c and 27d from a shock releasing event. Similarly, release valve 55b is operatively configured to release hydraulic fluid from chambers 26c and 26d when the pressure in such chambers exceeds a threshold value. Check valve 56b is in turn operatively configured to open line 35 to tank 30 via negative pressure in line 35 and chambers 25c and 25d upon sudden release of fluid and pressure from line 36, with reservoir 30 recharged and discharged, as appropriate, to accommodate differential fluid volumes on each side of pistons 27c and 27d from a shock releasing event.

In this embodiment, hydraulic manifold assembly 50b also includes pressure sensor assembly 42, which includes pressure transducer 42a and pressure transducer 42b. Pressure transducer 42a is in line 35 between braking valve 58b and chambers 25c and 25d and is configured to sense pressure in chambers 25c and 25d, including when hydraulic brake valve 58b is closed and bucket 18 is held in a braked position within its lift range of motion, and provides a pressure input signal to controller 60. Similarly, pressure transducer 42b is in line 36 between braking valve 59b and chambers 26c and 26d and is configured to sense pressure in chambers 26c and 26d, including when hydraulic brake valve 59b is closed and bucket 18 is held in a braked position within its lift range of motion, and provides a pressure input signal to controller 60. Controller 60 and drive electronics 51b may thereby provide a current to motor 52b that corresponds to the sensed pressure feedback from pressure sensor 42 to remove any pressure differential between the opposite sides of hydraulic brakes 58b and 59b, respectively, and thereby to reduce any jump or jerk in pistons 27c and 27d when hydraulic brake valves 58b and 59b are opened and release their hold of pistons 27a and 27b and bucket 18 from a braked lift position.

Hydraulic manifold assembly 50c includes hydraulic brake valves 58c and 59c between pump 53c and hydraulic piston connections 37a, 37b, 38a and 38b. In particular, valve 58b is fluid line 37 between pump 53b and hydraulic piston connections 37a and 37b, and valve 59c is in line 38 between pump 53c and hydraulic piston connections 38a and 38b. Valves 58c and 59c are operatively configured to maintain pressure in lines 37 and 38 and provide a braking function independent of pump 53c. In this embodiment, valves 58c and 59c are both active valves that employ an external actuation force to open or close, rather than passive valves in which the operational state of open or closed is determined by the fluid the valve controls (e.g. a check valve). In this embodiment valves 58c and 59c are two-way two-port solenoid valves. When valves 58c and 59c are energized, the valve is held open, thereby allowing equalization of fluid pressure on each side of the valve and flow through the valve in either direction. When valves 58c and 59c are de-energized, the spring of the solenoid valve will bias it to blocked port and closed, thereby blocking flow in either direction through the valve. Thus, in the event of a power failure, valves 58c and 59c will close and maintain pressure in lines 37 and 38 from connections 37a, 37b, 38a and 38b.

Hydraulic manifold assembly 50c also includes hydraulic release valves 54c and 55c between pump 53c and connections 37a, 37b, 38a and 38b. In particular, release valve 54c is fluid line 37 between pump 53c and connections 37a and 37b, and release valve 55c is in line 38 between pump 53c and connections 38a and 38b. Release valves 54c and 55c communicate with tank 30 and include anticavitation check valves 56c and 57c. Release valve 54c is operatively configured to release hydraulic fluid from connections 37a and 37b when the pressure exceeds a threshold value. Check valve 57c is in turn operatively configured to open line 38 to tank 30 via negative pressure in line 38 upon sudden release of fluid and pressure from line 37. Thus, reservoir 30 is recharged and discharged, as appropriate, to accommodate the differential fluid volumes on each side of pump 53c from a shock releasing event. Similarly, release valve 55c is operatively configured to release hydraulic fluid from connections 38a and 38b when the pressure exceeds a threshold value. Check valve 56c is in turn operatively configured to open line 37 to tank 30 via negative pressure in line 37 upon sudden release of fluid and pressure from line 38, with reservoir 30 recharged and discharged, as appropriate, to accommodate differential fluid volumes on each side of pump 53c from a shock releasing event.

In this embodiment, hydraulic manifold assembly 50c also includes pressure sensor assembly 43, which includes pressure transducer 43a and pressure transducer 43b. Pressure transducer 43a is in line 37 between braking valve 58b and connections 37a and 37b and is configured to sense pressure, including when when hydraulic brake valve 58c is closed, and provides a pressure input signal to controller 60. Similarly, pressure transducer 43b is in line 38 between braking valve 59c and connections 38a and 38b and is configured to sense pressure, including when hydraulic brake valve 59c is closed, and provides a pressure input signal to controller 60. Controller 60 and drive electronics 51c may thereby provide a current to motor 52c that corresponds to the sensed pressure feedback from pressure sensor 43 to remove any pressure differential between the opposite sides of hydraulic brakes 58c and 59c, respectively, and thereby reduce any jump or jerk from such a pressure differential when hydraulic brake valves 58c and 59c are opened.

Pilot operated check valves 44a and 44b are between tank 39 and lines 33 and 34 from pump 53a. The function of this anti-cavitation configuration is to address the volumetric differences between opposed chambers 25a, 25b and 26a, 26b. For example, when piston 27a retracts within cylinder 24a, the volume of fluid removed from collapsing chamber 25a will be greater than the volume of fluid supplied to expanding right chamber 26a because of rod 28a absent reservoir tank 30 and line 39. Similarly, pilot operated check valves 45a and 45b are between tank 39 and lines 35 and 36 from pump 53b to address the volumetric differences between opposed chambers 25c, 25d and 26c, 26d. Similarly, pilot operated check valves 46a and 46b are between tank 39 and lines 37 and 38 from pump 53c to address and volumetric differences there may be with any attached accessories.

Thus, oil reservoir or tank 30 is connected to hydraulic manifold modules 50a, 50b and 50c via fluid line 39 and compensates for volumetric differences in the system and thermal oil expansion and contraction within the system. Tank 30, line 39, pumps 53a, 53b and 53c, fluid lines 33-37, and valves 54a-c, 55a-c, 56a-c, 57a-c, 58a-c and 59a-c form a closed fluid system. The electrohydraulic system is a closed hydraulic system in that fluid is not supplied to the system from an external source in operation. Nor is fluid permitted to drain to an external sump in operation. Reservoir 30 is either discharged or recharged, as appropriate, to accommodate differential fluid volumes.

Controller 60 receives drive commands, such as from joystick controls, and feedback from sensors in the system, such as the position of pistons 27a and 27b monitored via position transducers and/or pressure from transducers 41-43, and provides commands to drive electronics 51a-c and/or brakes 58a-c and 59a-c accordingly. Motor controller 60 supplies current command signals to power stages 51a, 51b and 51c, which in turn supply current of the appropriate magnitude and polarity to motors 52a, 52b and 52c, respectively, with such commands based in part on angular position feedback from resolvers and pressure transducers. Variable speed bidirectional motors 52a and 52b and pumps 53a and 53b control the speed and force of pistons 27a-d, and in turn rods 28a-d, by changing the flow and pressure acting on pistons 27a-d, respectively, by looking at position and pressure feedback and then closing the control loop by adjusting the speed and direction of motors 52a and 52b, respectively. Additional and/or alternative pressure and/or position sensors may be used in system 15 and signals fed back to controller 60.

Power source 19 may include a regenerative power circuit to take advantage of a regenerative mode in which motors 52a, 52b and/or 52c are controlled to operate as a generator in a power generation mode when external regenerative forces, such as gravity loads, on hydraulic assemblies 50a, 50b or 50c exceed a threshold drive pressure differential of pumps 53a, 53b, or 53c and drive torque of motors 52a, 52b or 52c, respectively. When bucket 18 and/or other accessories of skid steer 16 need to absorb gravitational forces and impact forces, each of motors 52a, 52b and 52c may be configured to operate as electric generators that convert torque generated from such forces on the system into electricity that is stored in battery storage 19. For example, the effects of gravity when bucket 18 is raised will generate a force on pistons 27c and 27d of cylinders 21a and 21b, which in turn produces pressure on pump 53b when brakes 58b and 59b are not activated, which in turn produces a torque on the shaft of servomotor 52b. Under these conditions and in the regenerative mode, electric motor 52b is configured to act as an electric generator. Regenerative power stage 51b and motor controller 60 detect the armature current generated by motor 52b in this capacity and transfers such current of the appropriate magnitude and polarity of motor 52b into battery 19. Thus, actuator system 15 may include regenerative energy functionality.

Actuation system 15 provides a number of benefits. In system 15, regenerative power from gravity loads can be transferred back to battery 19. System 15 absorbs high shock loading and extreme impacts to bucket 18. System 15 has high energy efficiency that minimizes the size of battery pack 19. System 15 has the ability to manage heat from a harsh duty cycle. System 15 does not result in cylinder drop when going from cylinder lock to unlock under load conditions. System 15 can provide a high dynamic response of at least 30 milliseconds step response and at least 80 Hz frequency response to allow for autonomous operation.

It should be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. While the presently preferred form of an improved battery powered actuator system for mobile machines has been shown and described, and several modifications thereof discussed, persons skilled in this art will readily appreciate that various additional changes and modifications may be made without departing from the scope of the invention, as defined and differentiated by the claims.

1. A mobile machine comprising:
an object configured to be driven relative to a body portion of said mobile machine;
an electric storage;
an electric motor connected to said electric storage and configured to be supplied with a current and to operatively provide a torque on an output shaft;
a hydraulic pump driven by said output shaft of said electric motor;
a hydraulic piston assembly hydraulically connected to said hydraulic pump and comprising a housing having a first chamber and a second chamber, and a piston separating said first and second chambers of said housing;
an actuating rod connected to said piston and configured to move linearly with said piston relative to said housing;
one of said housing or said actuating rod connected to said mobile machine and the other of said housing or said actuating rod connected to said object to be driven;
said hydraulic piston assembly configured to actuate said object to be driven relative to said mobile machine within a range of motion; and
wherein actuation of said object to be driven relative to said body portion of said mobile machine within said range of motion is controllable by said electric motor and powered via said electric storage.

2. The mobile machine set forth in claim 1, comprising a hydraulic release between said pump and said hydraulic piston assembly operatively configured to release hydraulic fluid from said first chamber or said second chamber when a pressure in said first chamber or said second chamber exceeds a threshold value.

3. The mobile machine set forth in claim 2, wherein said hydraulic release comprises a first release valve between said first chamber and said pump, a second release valve between said second chamber and said pump, a first check valve between said first chamber and said second release valve, and a second check valve between said second chamber and said first release valve.

4. The mobile machine set forth in claim 1, comprising a hydraulic brake between said pump and said hydraulic piston assembly operatively configured to hold said object to be driven relative to said mobile machine in a braked position within said range of motion.

5. The mobile machine set forth in claim 4, wherein said hydraulic brake comprises a solenoid valve between said first chamber and said second chamber.

6. (canceled)

7. The mobile machine set forth in claim 4, comprising:
a controller that receives input signals and outputs command signals to said electric motor to control actuation of said object to be driven relative to said body portion of said mobile machine;
a pressure sensor configured to sense a braking pressure of said hydraulic piston assembly when said object to be driven is held in said braked position within said range of motion by said hydraulic brake and to provide a pressure input signal to said controller; and
wherein said electric motor is controlled b said controller based on said pressure input signal when said hydraulic brake releases said hold of said object to be driven from said braked position.

8. (canceled)

9. The mobile machine set forth in claim 1, comprising:
a second hydraulic piston assembly hydraulically connected to said hydraulic pump and comprising a second housing having a first chamber and a second chamber, and a second piston separating said first and second chambers of said second housing;
a second actuating rod connected to said second piston and configured to move linearly with said second piston relative to said second housing;
one of said second housing or said second actuating rod connected to said mobile machine and the other of said second housing or said second actuating rod connected to said object to be driven;
said second hydraulic piston assembly configured to actuate said object to be driven relative to said body portion of said mobile machine within said range of motion; and
wherein actuation of said object to be driven relative to said body portion of said mobile machine within said second range of motion is controllable by said electric motor and powered via said electric storage.

10. The mobile machine set forth in claim 1, comprising:
a second electric motor connected to said electric storage and adapted to be supplied with a current and to operatively provide a torque on a second output shaft;
a second hydraulic pump driven by said second output shaft of said second electric motor;
a second hydraulic piston assembly hydraulically connected to said second hydraulic pump and comprising a second housing having a first chamber and a second chamber, and a second piston separating said first and second chambers of said second housing;
a second actuating rod connected to said second piston and configured to move linearly with said second piston relative to said second housing;
one of said second housing or said second actuating rod connected to said mobile machine and the other of said second housing or said second actuating rod connected to said object to be driven;
said second hydraulic piston assembly configured to actuate said object to be driven relative to said mobile machine within a second range of motion; and
wherein actuation of said object to be driven relative to said body portion of said mobile machine within said second range of motion is controllable by said second electric motor and powered via said electric storage.

11. The mobile machine set forth in claim 10, wherein said range of motion comprises rotational motion about a tilt axis and said second range of motion comprises translational motion along a lift axis.

12. The mobile machine set forth in claim 11, wherein said mobile machine comprises a skid steer loader and said object to be driven comprises a bucket configured to be lifted and tilted relative to said body portion of said mobile machine.

13. The mobile machine set forth in claim 10, comprising:
a fluid reservoir connected to said hydraulic pump, said second hydraulic pump, said hydraulic piston assembly, and said second hydraulic piston assembly; and
wherein said hydraulic pump, said second hydraulic pump, said hydraulic piston assembly, said second hydraulic piston assembly, and said reservoir are connected in a substantially closed hydraulic system.

14. The mobile machine set forth in claim 1, comprising:
a second object configured to be driven relative to said body portion of said mobile machine;
a second electric motor connected to said electric storage and adapted to be supplied with a current and to operatively provide a torque on a second output shaft;
a second hydraulic pump driven by said second output shaft of said second electric motor;
a second hydraulic piston assembly hydraulically connected to said second hydraulic pump and comprising a second housing having a first chamber and a second chamber, and a second piston separating said first and second chambers of said second housing;
a second actuating rod connected to said second piston and configured to move linearly with said second piston relative to said second housing;
one of said second housing or said second actuating rod connected to said mobile machine and the other of said second housing or said second actuating rod connected to said second object to be driven;
said second hydraulic piston assembly configured to actuate said second object to be driven relative to said mobile machine within a second range of motion; and
wherein actuation of said second object to be driven relative to said body portion of said mobile machine within said second range of motion is controllable by said second electric motor and powered via said electric storage

15. The mobile machine set forth in claim 14, comprising:
a fluid reservoir connected to said hydraulic pump, said second hydraulic pump, said hydraulic piston assembly, and said second hydraulic piston assembly; and
wherein said hydraulic pump, said second hydraulic pump, said hydraulic piston assembly, said second hydraulic piston assembly, and said reservoir are connected in a substantially closed hydraulic system.

16. (canceled)

17. The mobile machine set forth in claim 1, comprising a controller that receives input signals and outputs command signals to said electric motor to control actuation of said object to be driven relative to said body portion of said mobile machine.

18. The mobile machine set forth in claim 17, comprising a regenerative power stage to said electric motor and wherein said electric motor is controlled by said controller to operate in a regeneration mode.

19. The mobile machine set forth in claim 17, comprising at least one of a position sensor configured to sense a position of said first piston and to provide an input signal to said controller and a pressure sensor configured to sense pressure in said first chamber and/or said second chamber and to provide an input signal to said controller.

20. (canceled)

21. The mobile machine set forth in claim 1, wherein said electric motor is a variable speed bidirectional electric motor adapted to operatively provide a torque on said output shaft at varying speeds and by direction, said hydraulic pump is a reversible variable speed hydraulic pump, and actuation of said object to be driven relative to said body portion of said mobile machine within said range of motion is controllable by adjusting said speed and/or direction of said variable speed bidirectional electric motor.

22. The mobile machine set forth in claim 1, wherein said electric motor comprises a brushless DC servo-motor and said hydraulic pump is selected from a group consisting of a fixed displacement pump, a variable displacement pump, a two-port pump, and a three-port pump.

23. (canceled)

24. The mobile machine set forth in claim 1, wherein:
said piston comprises a first surface area exposed to said first chamber of said housing and a second surface area exposed to said second chamber of said housing;
said housing comprises a cylinder having a first end wall, wherein said piston is disposed in said cylinder for sealed sliding movement therealong, and wherein said actuator rod is connected to said piston for movement the therewith and comprises a portion sealing penetrating said first end wall; and
said housing is connected to said body portion of said mobile machine and said actuating rod is connected to said object to be driven.

25. (canceled)

26. (canceled)

27. The mobile machine set forth in claim 1, comprising a fluid reservoir connected to said hydraulic pump and said hydraulic piston assembly, and wherein said hydraulic pump, said hydraulic piston assembly and said reservoir are connected in a substantially closed hydraulic system.
